(19) United States
(12) Patent Application Publication
(10) Pub. No.: US 2025/0244538 A1
(43) Pub. Date: Jul. 31, 2025

(54) MCF CONNECTION SYSTEM AND MCF CONNECTION METHOD

(71) Applicant: NEC Corporation, Minato-ku, Tokyo (JP)

(72) Inventor: Yuushi MATSUO, Tokyo (JP)

(73) Assignee: NEC Corporation, Minato-ku, Tokyo (JP)

(21) Appl. No.: 18/851,319

(22) PCT Filed: Mar. 31, 2022
(86) PCT No.: PCT/JP2022/016418

§ 371 Date: Sep. 26, 2024

(51) Int. Cl. G02B 6/38

(52) U.S. Cl. CPC G02B 6/3803

(57) ABSTRACT

An MCF connection system includes: MCF transmission path that has cores of a quantity of N; a first FIFO; a light source that outputs, to one end of the first FIFO, a quantity of N inspection lights having mutually different characteristics; a connection device that optically connects a first end part forming one end of the MCF transmission path and the other end of the first FIFO; an identification device that identifies a characteristic of an inspection light output from a second end part forming the other end of the MCF transmission path; and a measurement device that measures, for each core of the MCF transmission path, a first optical power, which is the optical power of the inspection light output from the second end part, in correspondence with the characteristic.

### TECHNICAL FIELD

The present invention relates to an MCF connection system and the like for connecting multi core fibers to be used in an optical fiber transmission system.

### BACKGROUND ART

Recently, with demand expansion of international data communication, importance of a submarine cable system enabling large-capacity and high-speed communication is increasing. As one means for expanding a transmission capacity without changing an outer diameter of a submarine cable, research and development of a multi core fiber (MCF) is advancing. The MCF is an optical fiber including a plurality of cores in one optical fiber.

In order to connect a general optical device including an interface of a single core fiber (SCF) having one core in one optical fiber to an optical transmission path including an MCF, a fan-in/fan-out (FIFO) is used. The general optical device is, for example, an optical repeater and an optical component. The FIFO is an optical component in which one end includes a plurality of SCFs and another end is an MCF, and inside the FIFO, cores of the SCFs and cores of the MCF are connected. Therefore, the FIFO can connect an optical device in which an SCF is an interface and an MCF.

In relation to the present invention, PTL 1 describes an axis alignment method for a coupled multi core optical fiber. PTL 2 describes an MCF including a marker for positioning cores.

### CITATION LIST

### Patent Literature

PTL 1: International Patent Publication No. WO2017/217539

PTL 2: International Patent Publication No. WO2012/121027

### SUMMARY OF INVENTION

### Technical Problem

When a FIFO and an MCF are connected, each core of the FIFO and each core of the MCF are preferably connected with low loss. Preferably, a variation in connection loss between each core of the FIFO and each core of the MCF is small. In contrast, in a general procedure for connecting a FIFO and an MCF, a plurality of pieces of light distributed from a single light source are input to one end of the MCF via the FIFO. Then, an optical axis adjustment is made between one end of the FIFO and one end of the MCF in such a way that a sum of optical power being output from all cores in another end of the MCF is maximized.

However, in such a procedure, there is a problem that it cannot be easily known whether each of cores of an MCF can be connected to a FIFO with low loss. The reason is that, in a connection point between one end of the FIFO and one end of the MCF, a connection state for each core cannot be known. Therefore, in order to connect an MCF and a FIFO (hereinafter, referred to as a “first FIFO”) while reducing a variation in connection loss for each core, the following procedures from (a) to (d) are required.
(a) Connect one end of an MCF to a FIFO (first FIFO) (a first optical axis adjustment).
(b) In order to optimize connection of the first FIFO, input inspection light from the first FIFO, and connect another end of the MCF to another FIFO (second FIFO).
(c) Input inspection light from the second FIFO for each core.
(d) Disconnect the connection between the first FIFO and one end of the MCF, and between the first FIFO and the one end of the MCF, perform a second optical axis adjustment in such a way as to reduce a variation in connection loss for each core.

In other words, in the general procedure, after connection between a first FIFO and an MCF, the procedures (b) to (d) for disconnecting the connection and performing an optical axis adjustment based on inspection light in an opposite direction are required. Therefore, in the general procedure, it is difficult to simply connect an MCF and a FIFO with high quality.

### Object of Invention

An object of the present invention is to provide a technique for simply connecting an MCF and a FIFO with high quality.

### Solution to Problem

An MCF connection system according to the present invention includes:
a multi core fiber (MCF) transmission path including N cores;
a first fan-in/fan-out (FIFO);
a light source that outputs, to one end of the first FIFO, N pieces of inspection light having different characteristics from one another;
a connection means for optically connecting a first end part forming one end of the MCF transmission path and another end of the first FIFO;
an identification means for identifying a characteristic of the inspection light being output from a second end part forming another end of the MCF transmission path; and
a measurement means for measuring, for each core of the MCF transmission path, first optical power indicating optical power of each core of the inspection light being output from the second end part, in association with the characteristic, wherein
N is an integer equal to or more than two,
the light source inputs the inspection light to each of a plurality of cores in one end of the first FIFO, and
the connection means adjusts, for each core, an optical axis between another end of the first FIFO and the first end part in such a way that a value of each piece of the first optical power falls within a predetermined range, and, after adjusting an optical axis between another end of the first FIFO and the first end part, fixes connection between another end of the first FIFO and the first end part.

An MCF connection method according to the present invention is
an MCF connection method including a first procedure for optically connecting an MCF transmission path including N cores and a first FIFO, wherein
N is an integer equal to or more than two,
the first procedure includes a procedure of:
inputting, to each of a plurality of cores in one end of the first FIFO, inspection light having different characteristics from one another;
optically connecting, for each core, another end of the first FIFO and a first end part forming one end of the MCF transmission path;
identifying a characteristic of the inspection light being output from a second end part forming another end of the MCF transmission path;
measuring, for each core of the MCF transmission path, first optical power indicating optical power of each core of the inspection light being output from the second end part, in association with the characteristic;
adjusting an optical axis between another end of the first FIFO and the first end part in such a way that a value of each piece of the first optical power falls within a predetermined range; and
fixing connection between another end of the first FIFO and the first end part.

### Advantageous Effects of Invention

The present invention is able to simply connect a FIFO and an MCF with high quality.

### BRIEF DESCRIPTION OF DRAWINGS

FIG. 1 is a diagram illustrating an MCF connection system.

FIG. 2 is a diagram illustrating an optical axis adjustment of an MCF.

FIG. 3 is an example of a flowchart of a first procedure.

FIG. 4 is a diagram illustrating an MCF connection system.

FIG. 5 is an example of a flowchart of a second procedure.

FIG. 6 is a diagram illustrating an MCF connection system.

FIG. 7 is a diagram illustrating an MCF connection system.

FIG. 8 is a block diagram illustrating a configuration example of a light source.

### EXAMPLE EMBODIMENT

Example embodiments according to the present invention are described below. An arrow in drawings is added as an example for illustrating a direction of a signal according to the example embodiments and does not indicate limitation to the direction. An intersection between lines does not indicate, unless otherwise specified, coupling of signals and the like different in direction. An already-described element is assigned with the same name and reference sign, and overlapping description is omitted according to the example embodiments.

### First Example Embodiment

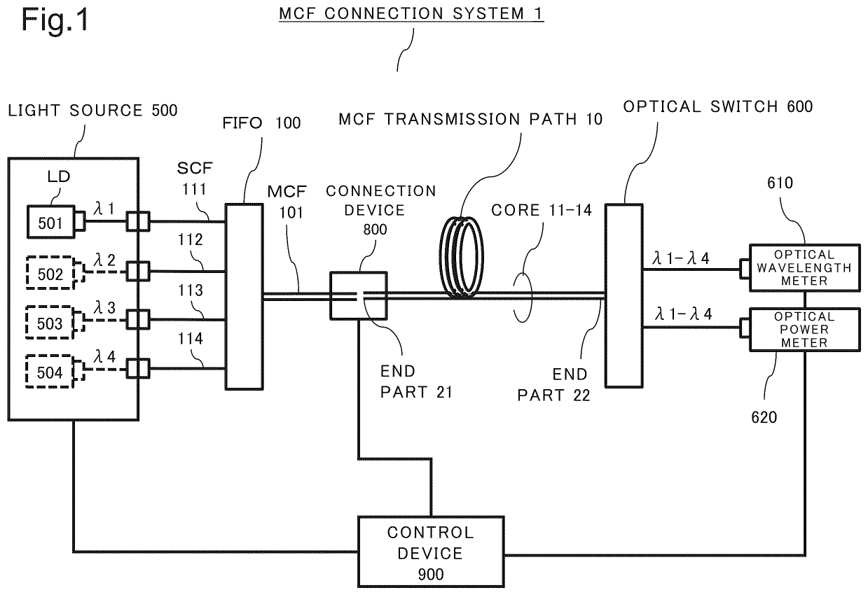

According to the present example embodiment, an MCF connection system and an MCF connection method for connecting a FIFO 100 to one end of an MCF transmission path 10 are described. FIG. 1 is a diagram illustrating an MCF connection system 1 according to a first example embodiment of the present invention.

The MCF transmission path 10 is an optical transmission path configured by using an MCF. In the MCF transmission path 10, a plurality of cores are formed inside one optical fiber. The MCF transmission path 10 is a non-coupled MCF in which each core can transmit light independently. The FIFO 100 is a fan-in/fan-out (FIFO) for connecting the MCF transmission path 10 to a plurality of SCFs. One end of the FIFO 100 is an MCF (MCF 101), and the other end is an SCF (SCFs 111 to 114). In the FIFO 100, cores of the MCF 101 are connected to cores of the SCFs 111 to 114 on a one-on-one basis. In other words, the FIFO 100 can connect an optical device including an MCF interface and an optical device including a plurality of SCF interfaces. One end of the MCF transmission path 10 is connected to the FIFO 100, and thereby in an optical transmission system including the MCF transmission path 10 as an optical transmission path, an optical device (e.g. an optical repeater and an optical component included in an optical repeater) including an SCF as an interface and the MCF transmission path 10 can be connected.

An MCF connection method to be described according to the present example embodiment is thereafter referred to as a first procedure. In the first procedure, the MCF transmission path 10 is connected to the FIFO 100. According to the present example embodiment, a case where the MCF transmission path 10 is a four-core MCF (an MCF including four cores 11 to 14) is described. The MCF 101 in one end of the FIFO 100 is also a four-core MCF, and the SCFs 111 to 114 each are an SCF. However, the following procedure is applicable to a case where the MCF transmission path 10 is an N-core MCF. Herein, N is a natural number equal to or more than two.

In FIG. 1, the MCF connection system 1 includes an MCF transmission path 10, a FIFO 100, a light source 500, an optical switch 600, an optical wavelength meter 610, an optical power meter 620, and a connection device 800. The MCF connection system 1 may include a control device 900. The control device 900 controls, in order to execute a first procedure, the light source 500, the optical switch 600, the optical wavelength meter 610, and the optical power meter 620. The control device 900 is one form of a control means.

The light source 500 can output any one of four pieces of inspection light having different characteristics. According to the present example embodiment, a case where the characteristic is a wavelength of inspection light is described. In other words, the light source 500 outputs four pieces of inspection light having different wavelength from one another. The number of wavelengths is a core number of the MCF transmission path 10. The light source 500 includes laser diodes (LDs) 501 to 504. The LDs 501 to 504 each are, for example, a semiconductor laser diode. Inspection light of a wavelength λ1 output by the LD 501 is input to the SCF 111 of the FIFO 100. Similarly, pieces of inspection light of wavelengths λ2, λ3, and λ4 output by the LD 502, the LD 503, and LD 504 each are input to the SCFs 112, 113, and 114. The wavelengths λ1 to λ4 of the inspection light input to the SCFs 111 to 114 of the FIFO 100 are different from one another, and therefore all wavelengths of inspection light output from cores of the MCF 101 of the FIFO 100 are different. The light source 500 according to the present example embodiment outputs only one piece of inspection light at the same time from among four pieces of inspection light of wavelengths λ1 to λ4. In other words, the light source 500 outputs inspection light to any one of the SCFs 111 to 114. The FIFO 100 and the MCF transmission path 10 are optically connected in such a way as to input, to the core 11, the core 12, the core 13, and the core 14 of the MCF transmission path 10, inspection light of a wavelength λ1, a wavelength λ2, a wavelength λ3, and a wavelength λ4, relevantly.

The connection device 800 includes a function of adjusting a position relation between two MCFs and fixing, based on fusion, connection between the MCFs. Specifically, the connection device 800 adjusts an optical axis between the MCF 101 and the MCF transmission path 10 in such a way that cores of the both are optically coupled. The core of the MCF 101 and the core of the MCF transmission path 10 are connected by a butt joint during an optical axis adjustment and then, fusion-spliced after termination of the optical axis adjustment. As the connection device 800, a general fusion splicer for fusion-splicing two MCFs is usable.

FIG. 1 illustrates a case where only the LD 501 emits light. When a wavelength of inspection light is λ1, the LDs 502 to 504 are not involved in an optical axis adjustment, and therefore blocks of these LDs are illustrated by a dashed line.

In the procedure according to the present example embodiment, the MCF 101 of the FIFO 100 and a first end part (end part 21) forming one end of the MCF transmission path 10 are optically connected for every four cores 11 to 14. In the end part 21, pieces of inspection light having different wavelengths from one another are input from the light source 500 to the cores 11 to 14 each. Thereby, the cores 11 to 14 of the MCF transmission path 10 transmit pieces of inspection light having different wavelengths from one another. Four pieces of inspection light are output from the cores 11 to 14 in an end part 22 forming the other end of the MCF transmission path 10.

Pieces of inspection light being output from the cores 11 to 14 in the end part 22 are input to the optical switch 600. The optical switch 600 outputs the input inspection light to the optical wavelength meter 610 or the optical power meter 620. The optical switch 600 is a 1×2 optical switch capable of outputting, to either of two SCFs, light input from element wire (a bare fiber) of the MCF transmission path 10.

The optical wavelength meter 610 measures a wavelength of inspection light input from the optical switch 600 and outputs a measurement result. Instead of the optical wavelength meter 610, an optical spectrum analyzer is usable. The optical power meter 620 measures power of light input from the optical switch 600 and outputs a measurement result. Instead of the optical switch 600, an optical coupler is usable. The optical coupler instead of the optical switch 600 distributes inspection light output from the end part 22 to the optical wavelength meter 610 and the optical power meter 620. When such an optical coupler is used, a wavelength and optical power of input inspection light can be measured at the same time.

The light source 500 outputs inspection light to any one of the SCFs 111 to 114, and therefore only inspection light of one wavelength is input to the optical wavelength meter 610 and the optical power meter 620 at the same time. Therefore, the optical wavelength meter 610 and the optical power meter 620 measure a wavelength and optical power of inspection light of one wavelength output by the light source 500. Any method of outputting measurement results of a wavelength and optical power is usable. These measurement results may be displayed in a display or may be transmitted, as data, to another device (e.g. the control device 900). The optical switch 600 outputs light input from the end part 22 to the optical wavelength meter 610 or the optical power meter 620. While in the light source 500, a wavelength of inspection light is switched, the optical switch 600 is controlled, and thereby a wavelength and optical power of inspection light propagating through the MCF transmission path 10 can be measured for each core of the MCF transmission path 10.

Herein, an optical axis is adjusted for each core between the FIFO 100 and the MCF transmission path 10 in such a way that a value of each piece of optical power in four cores measured in the optical power meter 620 falls within a predetermined range. When, for example, only the LD 501 emits light in the light source 500 and inspection light of a wavelength λ1 is input to the core 11 of the MCF transmission path 10, the optical wavelength meter 610 can detect that a wavelength of the inspection light is λ1. Thereby, it can be recognized that the inspection light output from the LD 501 is propagating through the core 11 of the MCF transmission path 10 via the SCF 111 of the FIFO 100 and the MCF 101. In other words, the SCF 111 and the core 11 are associated. Then, the optical switch 600 switches an output destination of inspection light from the optical wavelength meter 610 to the optical power meter 620. Thereby, the optical power meter 620 can measure optical power of the inspection light of a wavelength λ1 propagating through the core 11. From power of inspection light output by the light source 500, a loss in a path from the SCF 111 to the end part 22 via the core 11 can be also determined.

When an LD that outputs inspection light in the light source 500 is changed from the LD 501 to the LD 502, the LD 503, and LD 504, a core of the MCF transmission path 10 through which inspection light propagates is also changed to the core 12, the core 13, and the core 14 each. Then, after in the optical wavelength meter 610, a wavelength of inspection light is determined, an output destination of the inspection light is switched from the optical wavelength meter 610 to the optical power meter 620. As a result, optical power of each piece of inspection light output from the cores 12 to 14 and a loss in a path via the cores 12 to 14 are measured based on a procedure, similarly to the case of the core 11. When, for example, a light source of inspection light is switched from the LD 501 to the LD 502, inspection light of a wavelength λ2 is output from a second core of the end part 22. Therefore, when in the optical wavelength meter 610, the inspection light of a wavelength λ2 is detected, as a result in that a wavelength of inspection light output by the light source 500 is switched to λ2, it can be determined that optical power and the like of inspection light propagating through the core 12 connected to the SCF 112 can be measured.

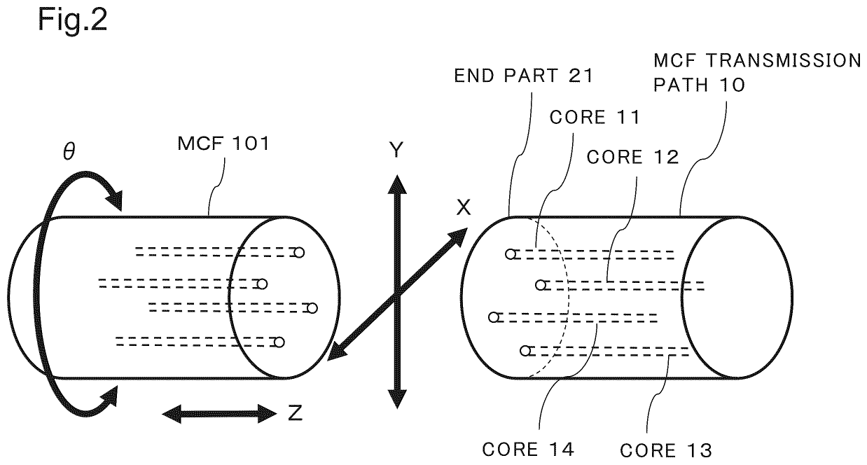

FIG. 2 is a diagram illustrating an optical axis adjustment of an MCF in the connection device 800. The connection device 800 can independently hold the MCF 101 and the MCF transmission path 10. The connection device 800 causes an end part of the MCF 101 and the end part 21 of the MCF transmission path 10 to be close to each other. The connection device 800 adjusts a relative position between an X axis, a Y axis, and a Z axis and a rotation angle θ around a center axis of the MCF 101 and the MCF transmission path 10 and makes an optical axis adjustment. According to optical power of inspection light measured in the optical power meter 620, an optical axis adjustment between the MCF 101 and the MCF transmission path 10 is made for each core, and thereby the FIFO 100 and the MCF transmission path 10 can be optically connected while a variation between cores is reduced. When pieces of optical power of inspection light output from the MCF 101 of the FIFO 100 are regarded to be equal, a difference in optical power between wavelengths of inspection light in the optical power meter 620 indicates a loss difference between cores leading from the SCFs 111 to 114 to the end part 22. These differences are preferably small. A connection loss between the FIFO 100 and the MCF transmission path 10 is also preferably small. In other words, an optical axis adjustment is preferably made in such a way that optical power of inspection light of each wavelength measured in the optical power meter 620 is increased. When both optical power of inspection light of each wavelength output from the MCF 101 and a loss in each of wavelengths of the cores 11 to 14 of the MCF transmission path 10 are known, the above-described adjustment may be made by using these known values.

For example, first, the light source 500 is caused to output inspection light of a wavelength λ1. An optical axis adjustment between the MCF 101 and the core 11 is made in the end part 21 in such a way that optical power of the inspection light is larger. Thereafter, a wavelength of inspection light output by the light source 500 is switched, and an optical axis adjustment is made for the MCF 101 and the cores 12 to 14, with respect to inspection light of each of wavelengths λ2, λ3, and λ4. In the optical axis adjustment, for example, between a cross-section of the MCF 101 and a cross-section of the end part 21, a position relation between cores each is adjusted. In the optical axis adjustment, a rotational angle around a center axis of the MCF 101 and the MCF transmission path 10 may be adjusted.

The above-described optical axis adjustment is made for inspection light of wavelengths λ1 to λ4 in such a way as to reduce a variation in optical power among pieces of the inspection light of wavelengths λ1 to λ4 measured by the optical power meter 620. As a result, between the MCF 101 and the end part 21, a variation in connection loss between cores can be reduced. In other words, the first procedure described according to the present example embodiment exhibits an advantageous effect enabling to simply connect the FIFO 100 and the MCF transmission path 10 with high quality. The reason is that according to the present procedure, for each set of cores 11 to 14 of the MCF transmission path 10, optical power of inspection light is measured in association with a characteristic of the inspection light. Thereby, the first procedure can be completed, differently from a general procedure, without, after a first optical axis adjustment between the FIFI 100 and the end part 21, disconnecting the connection and making a second optical adjustment (i.e. based on the first optical axis adjustment).

In this case, for each of wavelengths λ1 to λ4 (i.e. each core), a lower-limit value (first threshold) of optical power of inspection light is defined, and thereby an optical axis adjustment between the MCF 101 and the end part 21 may be terminated when optical power equal to or more than the first threshold is measured for all cores. Or, further, an upper-limit value (second threshold) of optical power is defined for each core, and thereby an optical axis adjustment between the MCF 101 and the end part 21 may be terminated when optical power equal to or more than the first threshold and equal to or less than the second threshold is measured for all cores.

After the optical adjustment, the FIFO 100 and the MCF transmission path 10 are fusion-spliced by using the connection device 800. When the FIFO 100 and the MCF transmission path 10 are fusion-spliced, the FIFO 100 and the MCF transmission path 10 are integrated. Thereby, high reliability of a portion where the FIFO 100 and the MCF transmission path 10 are connected is made possible. For connection between these two MCFs, a method other than fusion is applicable. For example, the MCF 101 and the MCF transmission path 10 can be fixed by using an adhesive using an ultraviolet-curable resin after termination of an optical axis adjustment.

Based on the above-described procedure, the FIFO 100 and the MCF transmission path 10 can be connected in such a way as to satisfy a condition for a predetermined loss by only a one-time optical axis adjustment. In other words, the MCF connection system 1 according to the present example embodiment can simply connect a FIFO and an MCF with high quality. At the time of the connection, optical power of inspection light is measured while cores 11 to 14 of an MCF to be connected to the FIFO 100 are identified, and thereby a loss in the MCF transmission path 10 can be determined.

### Another Description of First Example Embodiment

The above-described advantageous effect of the MCF connection system 1 is also exhibited based on the following configuration. A reference sign in FIG. 1 is placed in parentheses. In other words, an MCF connection system (1) includes an MCF transmission path (10) including N (N is an integer equal to or more than two) cores, a first FIFO (100), a light source (500), a connection means (800), an identification means (610), and a measurement means (620).

The light source (500) outputs N pieces of inspection light having different characteristics from one another to one end (SCFs 111 to 114) of the first FIFO (100). The connection means (800) optically connects a first end part (21) forming one end of the MCF transmission path (10) and the other end (101) of the first FIFO (100). The identification means (610) identifies a characteristic (a wavelength according to the first example embodiment) of inspection light output from a second end part (22). The measurement means (620) measures, for cores (11 to 14) each of the MCF transmission path (10), first optical power being optical power of the inspection light output from the second end part (22), in association with the characteristic of the inspection light.

The light source (500) inputs inspection light to a plurality of cores (SCFs 111 to 114) each in one end of the first FIFO (100). The connection means (800) adjusts, for each core, an optical axis between the other end (MCF 101) of the first FIFO and the first end part (21) in such a way that a value of each piece of first optical power falls within a predetermined range.

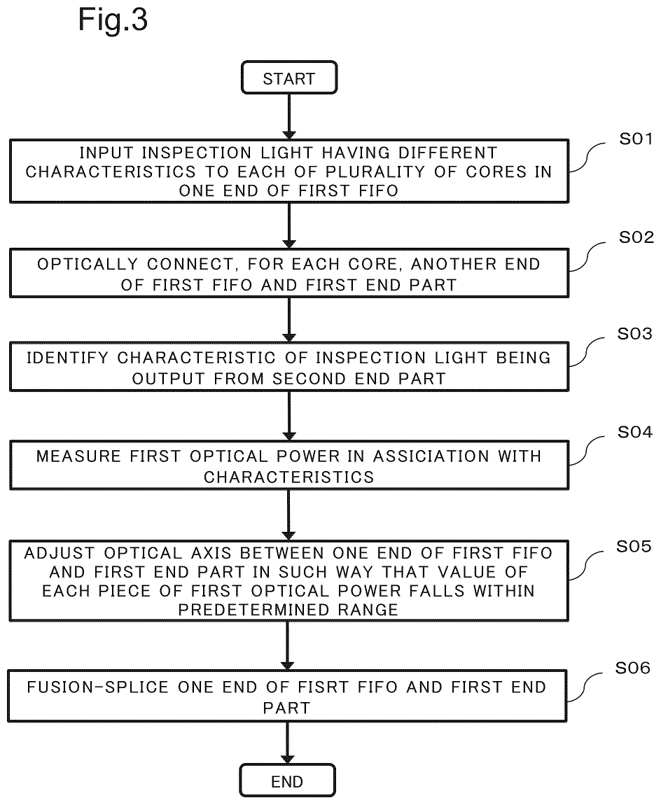

FIG. 3 is an example of a flowchart of the first procedure in the above-described description. In the first procedure, first, pieces of inspection light are input to a plurality of cores each in one end of a first FIFO (S01 in FIG. 3). The pieces of inspection light each have different characteristics from one another. The other end of the first FIFO and a first end part are optically connected for each core (S02). Characteristics of pieces of inspection light output from a second end part are identified (S03), and pieces of first optical power are measured in association with the characteristics (S04). An optical axis between one end of the first FIFO and the first end part is adjusted in such a way that each of values of the first optical power falls within a predetermined range (S05). Finally, one end of the first FIFO and the first end part are fusion-spliced (S06).

The MCF connection system 1 and the MCF connection method used for the system described in this manner also exhibit an advantageous effect enabling to simply connect a FIFO and an MCF with high quality.

### Second Example Embodiment

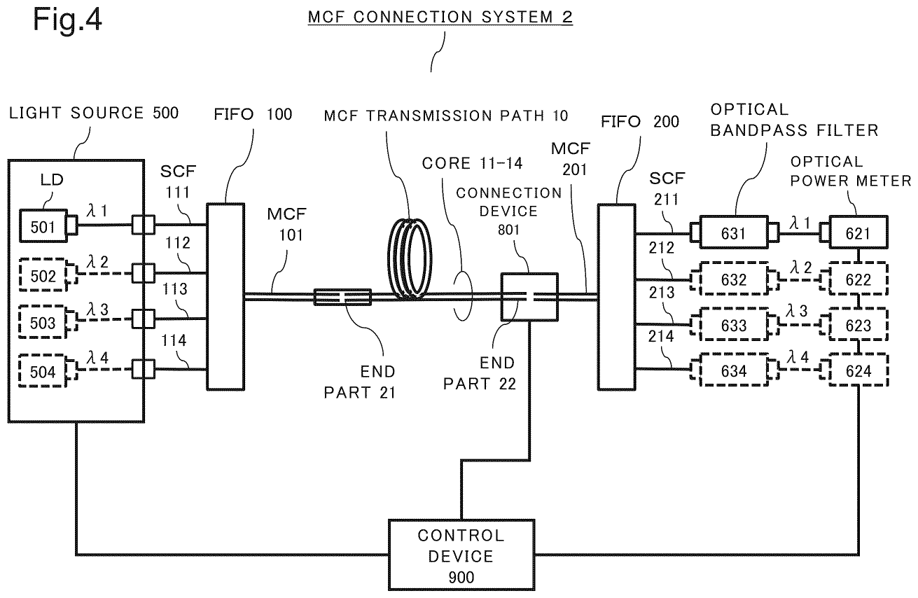

FIG. 4 is a diagram illustrating an MCF connection system 2 according to a second example embodiment. According to the second example embodiment, the other end (an end part 22) of an MCF transmission path 10 and an MCF 201 of a FIFO 200 are optically connected for each core. Also, according to the second example embodiment, a case where the MCF transmission path 10 is a four-core MCF is described. However, the number of cores of the MCF transmission path 10 is not limited to four cores.

The FIFO 200 is a fan-in/fan-out for connecting an MCF and four SCFs. One end of the FIFO 200 is the MCF 201, and the other end includes SCFs 211 to 214. In the FIFO 200, each core of the MCF 201 and each core of the SCFs 211-214 are connected on a one-on-one basis. In other word, the FIFO 200 can connect an optical device including an MCF interface and an optical device including a plurality of SCF interfaces.

In FIG. 4, an optical axis adjustment between the FIFO 100 and the MCF transmission path 10 has been terminated. The procedure described according to the first example embodiment is applicable to the optical axis adjustment. Hereafter, an MCF connection method described according to the present example embodiment is referred to as a second procedure. In the second procedure, an optical axis is adjusted by a connection device 801 in such a way that the end part 22 and the MCF 201 are optically coupled based on cores of the both in cross-sections of the both. For example, four cores of the MCF 201 and four cores 11 to 14 of the MCF transmission path 10 are optically connected by a butt-joint in the end part 22. A function of the connection device 801 is relevant to the function of the connection device 800 illustrated in FIG. 2. In other words, the connection device 801 can adjust an optical axis in such a way that between the MCF 201 and the MCF transmission path 10, cores of the both are optically coupled and can fix connection between the cores based on fusion after termination of the optical axis adjustment.

The SCFs 211 to 214 of the FIFO 200 each are input to optical power meters (OPMs) 621 to 624 via optical band pass filters (OBPFs) 631 to 634. The optical band pass filters 631, 632, 633, and 634 each are an optical filter that transmits only light of wavelengths being wavelengths λ1, λ2, λ3, and λ4. The optical power meters 621 to 624 each measure optical power of light transmitted through the optical band pass filters 631 to 634.

Based on such a configuration, in the MCF connection system 2, without using an optical switch 600 differently from the first example embodiment, pieces of optical power of inspection light each of wavelengths λ1, λ2, λ3, and λ4 can be measured by using the optical power meters 621 to 624.

Similarly to the first example embodiment, the light source 500 outputs inspection light of one wavelength from among wavelengths λ1, λ2, λ3, and λ4. FIG. 4 illustrates a case where only an LD 501 emits light and power of inspection light of a wavelength λ1 is measured by the optical power meter 621. When a wavelength of inspection light is λ1, LDs 502 to 504, the optical band pass filters 632 to 634, and the optical power meters 622 to 624 are not involved in an optical axis adjustment, and therefore blocks of these components are illustrated by a dashed line. Then, optical axis adjustments between the end part 22 and the SCFs 211 to 214 are made in such a way that values of pieces of optical power each output from the cores 11 to 14 measured in the optical power meters 621 to 624 fall within a predetermined range. In other words, according to optical power of inspection light measured in the optical power meters 621 to 624, an optical axis for each core between the MCF 201 and the end part 22 is adjusted. Thereby, cores of the MCF 201 and the cores 11 to 14 of the MCF transmission path 10 are optically connected with low loss while a variation in connection loss between cores is reduced. For example, while a wavelength of inspection light is changed, measurement values of the optical power meters 621 to 624 are observed and an optical axis adjustment between the MCF 201 and the end part 22 is repeated for each core, and thereby an optical axis between the cores 11 to 14 and the MCF 201 can be adjusted for each core. An optical axis adjustment procedure between the MCF 101 and the end part 21 is relevantly applicable to an optical axis adjustment between the MCF 201 and the end part 22. In other words, the light source 500 is caused to output inspection light of a wavelength 21. Then, an optical axis adjustment between the core 11 and the MCF 201 is made in the end part 22 in such a way that optical power of the inspection light is increased. Thereafter, a wavelength of inspection light output by the light source 500 is switched, and for inspection light of each of wavelengths λ2, λ3, and λ4, an optical axis adjustment is made between the MCF 201 and the cores 12 to 14. In the optical axis adjustment, for example, between a cross-section of the MCF 201 and a cross-section of the end part 22, a position relation between cores of the cross-sections is adjusted. In the optical axis adjustment, a rotational angle around a center axis of the MCF 201 and the MCF transmission path 10 may be adjusted.

For each of wavelengths λ1 to λ4, an optical axis adjustment is made between the MCF transmission path 10 and the MCF 201, and thereby a variation in connection loss for each core can be reduced. In this case, for each core, a lower-limit value (third threshold) of optical power of inspection light is defined, and thereby when for all cores, optical power equal to or more than the third threshold is measured, an optical axis adjustment between the MCF 201 and the end part 22 may be terminated. Alternatively, for each core, further, an upper-limit value (fourth threshold) of optical power is defined, and thereby, when for all cores, optical power equal to or more than the third threshold and equal to or less than the fourth threshold is measured, an optical axis adjustment between the MCF 201 and the end part 22 may be terminated.

Based on the above-described procedure, each core of the FIFO 200 and each core of the MCF transmission path 10 can be connected in such a way as to satisfy a condition for a predetermined loss. The connection can be performed by identifying cores of the FIFO 100 and the MCF transmission path 10. The reason is that when an optical axis adjustment between the end part 22 and the MCF 201 is made, based on a wavelength of inspection light, cores to be connected can be managed. When, for example, a transmission wavelength of the optical band pass filter 631 connected to the SCF 211 is set as a wavelength λ1, a path passing through the SCF 111 and the core 11 and the SCF 211 can be connected.

After coupling between the MCF 201 and the MCF transmission path 10 is adjusted, the connection therebetween is fixed by using the connection device 801. When the MCF 201 and the MCF transmission path 10 are fusion-spliced, the FIFO 200 and the MCF transmission path 10 can be integrated while a loss during optical axis adjustment is substantially maintained. Therefore, high reliability of a connected portion is made possible. Further, when subsequently to the procedure according to the first example embodiment, the procedure according to the second example embodiment is executed, the FIFO 100, the MCF transmission path 10, and the FIFO 200 can be integrated. Thereby, an optical device in which an SCF is an interface can be easily connected to both ends of the MCF transmission path 10. A method other than fusion is also applicable to connection between the two MCFs. The MCF 201 and the MCF transmission path 10 can be fixed, after termination of an optical axis adjustment, for example, by using an adhesive using an ultraviolet-curable resin.

The MCF connection systems 1 and 2 described according to the first example embodiment and the second example embodiment and the first procedure and the second procedure applicable to these systems exhibit an advantageous effect enabling to simply connect a FIFO to both ends of an MCF. The reason is that a wave length of inspection light is different with respect to each core, and therefore when one end (the end part 21) of the MCF transmission path 10 and the FIFO 100 are connected and the other end (the end part 22) of the MCF transmission path 10 and the FIFO 200 are connected, an optical axis can be adjusted while a connection loss is confirmed for each core. Thereby, connection between the FIFO 100 and the end part 21 and connection between the end part 22 and the FIFO 200 can be completed by a one-time optical axis adjustment for each of the above-described cases, without disconnecting connection after an optical axis adjustment.

When MCFs are fused, an MCF including a marker as a reference of a position of a core is known (see, for example, PTL 2). The marker is used in order to identify, in both ends of an MCF, positions of a plurality of cores included in the MCF. However, in order to connect such an MCF and a FIFO, a special fuser including a camera for visualizing a marker is required and in addition, there is a problem in that when a core number of an MCF is large, it may be difficult to identify a core even by using a marker. However, the MCF connection systems 1 and 2 described according to the first and second example embodiments make an optical axis adjustment between the FIFO 100 and the MCF transmission path 10 while identifying cores in both ends (the end parts 21 and 22) of the MCF transmission path 10 by using a wavelength of inspection light and connect the both. Therefore, for the MCF transmission path 10, a marker is not required. For the connection devices 800 and 801, a special function for visualizing a marker of an MCF transmission path is not required either.

### Another Description of Second Procedure

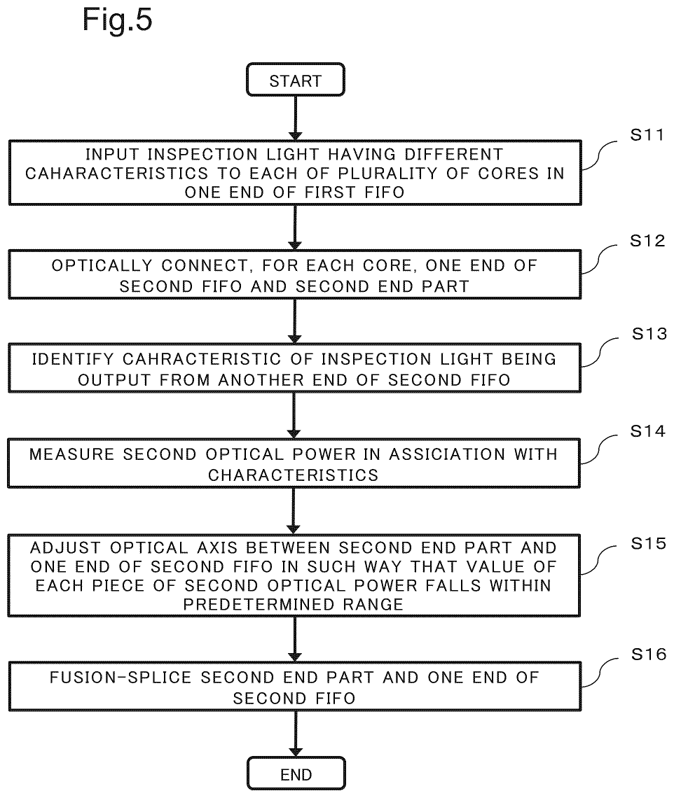

FIG. 5 is an example of a flowchart of a second procedure. The above-described second procedure is also described as in FIG. 5. The reference signs in FIG. 4 are placed in parentheses.

The second procedure is an MCF connection method executed after a first procedure. In the second procedure, first, similarly to the first procedure, pieces of inspection light are input to a plurality of cores (SCFs 111 to 114) each in one end of a first FIFO (100) (S11 in FIG. 5). The pieces of inspection light each have different characteristics from one another. Next, one end (MCF 201) of a second FIFO (200) and a second end part (22) are optically connected for each core (S12). Characteristics of inspection light output from the other end (SCFs 211 to 214) of the second FIFO (200) are identified (S13). In addition, pieces of second optical power being optical power of the inspection light output from the other end (SCFs 211 to 214) of the second FIFO (200) are measured for each core of an MCF transmission path (10), in association with the characteristics of the inspection light (S14). In this manner, an optical axis between the second end part (22) and one end (MCF 201) of the second FIFO is adjusted in such a way that a value of each piece of the second optical power falls within a predetermined range (S15). After termination of the optical axis adjustment, the second end part (22) and the one end (MCF 201) of the second FIFO are fusion-spliced (S16).

### Modified Example of Second Example Embodiment

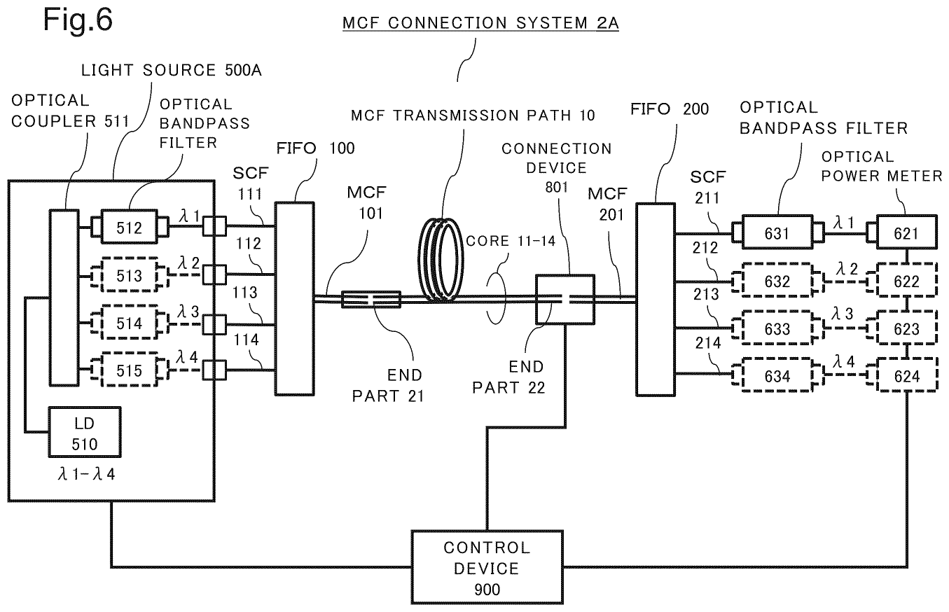

A modified example of the above-described MCF connection system 2 is described. FIG. 6 is a block diagram illustrating a configuration example of an MCF connection system 2A. In the MCF connection system 2A, instead of the light source 500 of the MCF connection system 2, a light source 500A is used.

The light source 500A includes an LD 510, an optical coupler 511, and optical bandpass filters 512 to 515. The LD 510 is a general wavelength-variable laser diode in which an oscillation wavelength is variable. The LD 510 outputs, based on control from an outside, light of any one of wavelengths λ1 to λ4 as inspection light. In other words, the light source 500A can output inspection light having a wavelength being any one of the wavelengths λ1 to λ4. The optical coupler 511 distributes the inspection light output by the LD 510 to cores of a FIFO 100. When there are four cores in the FIFO 100 and an MCF transmission path 10, the optical coupler 511 is, for example, a 1×4 coupler, and when the number of cores is N, the optical coupler 511 is, for example a 1×N coupler. Optical bandpass filters 512, 513, 514, and 515 each transmit only light of wavelengths λ1, λ2, λ3, and λ4. Thereby, pieces of inspection light having different wavelengths from one another are input to SCFs 111 to 114 of the FIFO 100. Therefore, also, when the light source 500A is used, all wavelengths of inspection light output from cores of an MCF 101 of the FIFO 100 are different. Also, when the light source 500A including such a configuration is used, the connection procedure between the FIFO 100 and the MCF transmission path 10 and the connection procedure between the MCF transmission path 10 and the FIFO 200 illustrated in FIG. 1 to FIG. 5 can be executed.

FIG. 6 illustrates a case where the LD 510 emits light at a wavelength 21 and power of inspection light of a wavelength λ1 is measured by an optical power meter 631. When a wavelength of inspection light is λ1, optical bandpass filters 513 to 515, optical bandpass filters 632 to 634, and optical power meter 622 to 624 are not involved in an optical axis adjustment, and therefore blocks for these components are illustrated by a dashed line.

### Third Example Embodiment

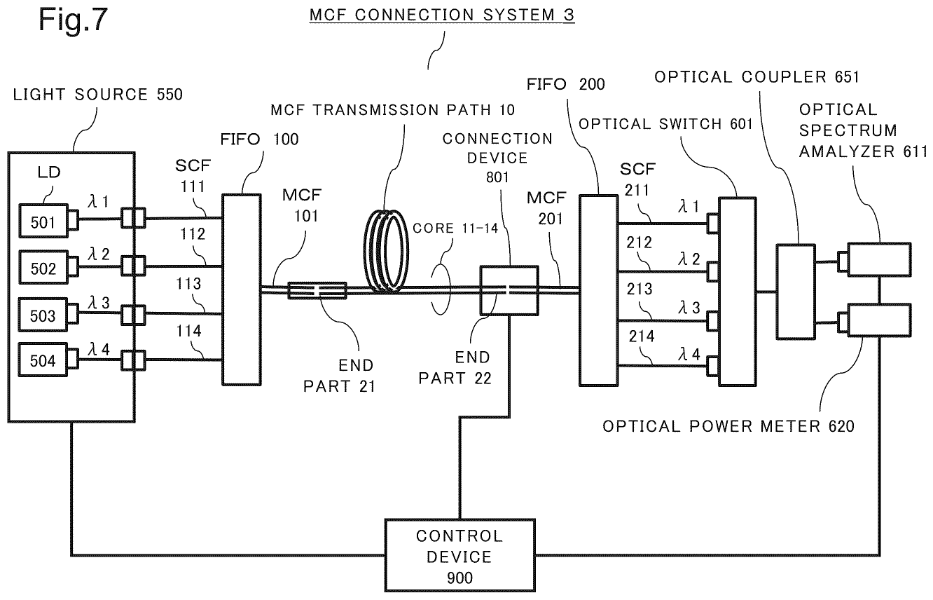

FIG. 7 is a diagram illustrating an MCF connection system 3 according to a third example embodiment of the present invention. According to the present example embodiment, a procedure in which after an end part 21 of an MCF transmission path 10 and a FIFO 100 are connected, an end part 22 of the MCF transmission path 10 and a FIFO 200 are connected is described. The procedure according to the present example embodiment may be executed, instead of the procedure described according to the second example embodiment. For connection between the MCF transmission path 10 and the FIFO 100, the procedure according to the first example embodiment is usable.

In the following description, similarly to the example embodiments so far, a case where the MCF transmission path 10 includes four cores is described. However, the following procedure and configuration are also applicable to a case where an MCF includes N cores.

In FIG. 7, the MCF connection system 3 includes, in addition to the MCF transmission path 10 and the FIFOs 100 and 200, a light source 550, an optical switch 601, an optical coupler 651, an optical spectrum analyzer (OSA) 611, and an optical power meter 620.

The light source 550 includes LDs 501 to 504. The LDs 501 to 504 each are, for example, a semiconductor laser diode. The LDs 501, 502, 503, and 504 each piece of output inspection light of wavelengths λ1, λ2, λ3, and λ4. The wavelengths λ1 to λ4 are different from one another. In other words, the light source 550 can output inspection light of wavelengths λ1 to λ4 at the same time. However, the light source 550 may output, from among the wavelengths λ1 to λ4, inspection light of three or less wavelengths. Therefore, the light source 550 is usable, instead of the light sources 500 and 500A described according to the first and second example embodiments

Before the procedure according to the present example embodiment, an MCF 101 of the FIFO 100 and the end part 21 of the MCF transmission path 10 are optically connected for every four cores. As a result, in the end part 21, pieces of inspection light having wavelengths different from one another are input from the light source 500 to four cores 11 to 14 each of the MCF transmission path 10. Thereby, pieces of inspection light having different wavelengths from one another are propagated through the cores 11 to 14 of the MCF transmission path 10 at the same time. Four pieces of inspection light are output from the cores 11 to 14 in the end part 22 forming the other end of the MCF transmission path 10.

Cores of the MCF 201 and the cores 11 to 14 of the MCF transmission path 10 are optically connected by a butt joint. Pieces of light output from four SCFs 211 to 214 of the FIFO 200 are input to an optical spectrum analyzer 611 and an optical power meter 620 via the optical switch 601 and the optical coupler 651. The optical switch 601 is a 4×1 switch and connects, to the optical coupler 651, one SCF selected from the SCFs 211 to 214. The optical coupler 651 is a 1×2 optical coupler and distributes light input from the optical switch 601 to the optical spectrum analyzer 611 and the optical power meter 620. The optical spectrum analyzer 611 measures a wavelength of inspection light of a core selected by the optical switch 601. In other words, the optical switch 601 selects a core in which a wavelength and optical power of inspection light are measured. The optical power meter 620 measures optical power of inspection light in the core selected by the optical switch 601.

Based on such a configuration, one piece of inspection light output from four SCFs 211 to 214 of the FIFO 200 is input, via the optical switch 601 and the optical coupler 651, to the optical spectrum analyzer 611 and the optical power meter 620.

The procedure according to the second example embodiment is applicable to an optical axis adjustment between the end part 22 of the MCF transmission path 10 and the MCF 201 of the FIFO 200. In other words, an optical axis adjustment is made between the end part 22 and the MCF 201 in such a way that a value of optical power measured in the optical power meter 620 falls within a predetermined range at each of wavelengths λ1 to λ4. The light source 550 is set in such a way as to output inspection light of wavelengths λ1 to λ4 at the same time, and thereby by using the optical spectrum analyzer 611 and the optical power meter 620, wavelengths and optical power of the inspection light of wavelengths λ1 to λ4 can be easily measured repeatedly. Herein, switching of a wavelength of inspection light is executed only based on switching of the optical switch 601. Then, an optical axis adjustment between the MCF 201 and the end part 22 is repeatedly made for each core, and thereby with respect to the cores 11 to 14, an optical axis, for each core, between the FIFO 200 and the MCF transmission path 10 can be preferably adjusted. Also, in such a procedure according to the present example embodiment, similarly to the second example embodiment, the cores 11 to 14 of the MCF transmission path 10 and cores of the MCF 201 can be optically connected with low loss while a variation in connection loss between cores is reduced.

### Modified Example of Third Example Embodiment

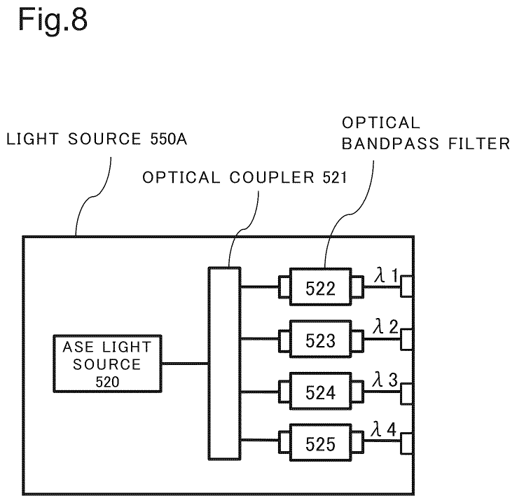

A modified example of the above-described MCF connection system 3 is described. FIG. 8 is a block diagram illustrating a configuration example of a light source 550A usable instead of the light source 550 of the MCF connection system 3

The light source 550A includes an amplified spontaneous emission (ASE) light source 520, an optical coupler 521, and optical bandpass filters 522 to 525. The ASE light source 520 outputs light (ASE light) having a wideband in which a spectrum is substantially flat. The ASE light can be generated by injecting excitation light into an optical amplification medium. A wavelength band of the ASE light includes wavelengths λ1 to λ4 of inspection light.

The optical coupler 521 distributes ASE light output by the ASE light source 520 to cores of the FIFO 100. When there are four cores in the FIFO 100 and the MCF transmission path 10, the optical coupler 521 is a 1×4 coupler, and when there are N cores, the optical coupler 521 is a 1×N coupler. The optical bandpass filters 522, 523, 524, and 525 each transmit only light of wavelengths λ1, λ2, λ3, and λ4. Thereby, from ASE light, pieces of inspection light of wavelengths λ1, λ2, λ3, and λ4 are generated at the same time. When the SCFs 111 to 114 of the FIFO 100 are connected to the light source 550A, pieces of inspection light of wavelengths λ1 to λ4 each are input to the SCFs 111 to 114. An optical attenuator may be connected in series to the optical bandpass filters 522 to 525. An attenuation amount in the optical attenuator may be set in such a way that pieces of optical power of inspection light of wavelengths each output from the light source 550 are equal to one another.

The light source 550A generates inspection light, by using ASE generated in the ASE light source 520 and the optical bandpass filters 522 to 525. Therefore, when a wavelength of inspection light is modified, transmission bands of the optical bandpass filters 522, 523, 524, and 525 may be modified, and therefore an expensive component such as a laser diode does not need to be modified.

Also, when the light source 550A is used, all wavelengths of inspection light output from cores of the MCF 101 of the FIFO 100 are different from one another. Also, by using the light source 500A including such a configuration, the first procedure and the second procedure described according to the above-described example embodiments can be executed.

### Fourth Example Embodiment

According to the first to third example embodiments, it was possible to identify, according to a difference of a wavelength of inspection light, a core of the MCF transmission path 10 through which inspection light propagates. However, a characteristic of inspection light used for identifying a core is not limited to wavelength. For example, pulse width modulation may be performed, based on widths different from one another, for four pieces of inspection light input to SCFs 111 to 114 of a FIFO 100. For example, pieces of inspection light input to four cores 11 to 14 of an MCF transmission path 10 are modulated in such a way as to have pulse widths W1 to W4 different from one another and also an optical receiver capable of identifying a pulse width of an optical signal is used, instead of the optical wavelength meter 610 and the optical spectrum analyzer 611. The optical receiver determines whether a pulse width of inspection light being received is any one of pulse widths W1 to W4 and thereby, can identify a core through which the inspection light propagates. In other words, also, when a characteristic of inspection light is set as a pulse width of inspection light, a core can be identified, similarly to a case where a characteristic of inspection light is set as a wavelength.

Inspection light is set as pulse light, and thereby a transmission interval of the pulse light may be changed for each core. For example, inspection light is set as a pulse train, and thereby inspection light of pulse intervals T1 to T4 different from one another may be propagated through cores each. In this case, instead of an optical wavelength meter and an optical spectrum analyzer, an optical receiver capable of identifying a reception interval of an optical pulse is used. Such an optical receiver determines whether a reception interval of a pulse of inspection light being received is any one of T1 to T4 and thereby, can identify a core through which the inspection light propagates. In other words, also, when a characteristic of inspection light is set as a pulse interval of inspection light, a core can be identified, similarly to a case where a characteristic of inspection light is set as a wavelength or a pulse width.

A modulation method for inspection light is not limited to pulse width or pulse interval. For example, pulse light may be amplitude-modulated by using a low frequency signal equal to or more than 10 kHz and equal to or less than 1 MHz. A modulation frequency is changed for each core and a frequency of a low frequency signal is detected by an optical receiver, and thereby a core through which the inspection light propagates may be identified.

When inspection light is set as pulse light, the inspection light may be modulated in such a way that duty ratios of pieces of inspection light each propagating through the cores 11 to 14 are equal to one another. Thereby, when optical power is measured, a difference in optical power of inspection light among the cores 11 to 14 can be avoided from an influence of duty ratio.

The whole or part of the example embodiments disclosed above can be described as, but not limited to, the following supplementary notes.

### Supplementary Note 1

An MCF connection system including:
a multi core fiber (MCF) transmission path including N cores;
a first fan-in/fan-out (FIFO);
a light source that outputs, to one end of the first FIFO, N pieces of inspection light having different characteristics from one another;
a connection means for optically connecting a first end part forming one end of the MCF transmission path and another end of the first FIFO;
an identification means for identifying a characteristic of the inspection light being output from a second end part forming another end of the MCF transmission path; and
a measurement means for measuring, for each core of the MCF transmission path, first optical power indicating optical power of each of the N cores of the inspection light being output from the second end part, in association with the characteristic, wherein
N is an integer equal to or more than two,
the light source inputs the inspection light to each of a plurality of cores in one end of the first FIFO, and
the connection means adjusts, for each core, an optical axis between another end of the first FIFO and the first end part in such a way that a value of each piece of the first optical power falls within a predetermined range, and, after adjusting an optical axis between another end of the first FIFO and the first end part, fixes connection between another end of the first FIFO and the first end part.

### Supplementary Note 2

The MCF connection system according to supplementary note 1, wherein
one end of the first FIFO includes a plurality of single core fibers (SCFs) included in the first FIFO, and
another end of the first FIFO is an MCF included in the first FIFO.

### Supplementary Note 3

The MCF connection system according to supplementary note 2, further including
a second FIFO, wherein
the connection means optically connects the second end part and one end of the second FIFO,
the measurement means measures, for each core of the MCF transmission path, second optical power being optical power of the plurality of pieces of inspection light being output from another end of the second FIFO, in association with the characteristic, and
the connection means adjusts an optical axis between the second end part and one end of the second FIFO in such a way that a value of each piece of the second optical power falls within a predetermined range.

### Supplementary Note 4

The MCF connection system according to supplementary note 3, wherein
one end of the second FIFO is an MCF included in the second FIFO, and
another end of the second FIFO includes a plurality of SCFs included in the second FIFO.

### Supplementary Note 5

The MCF connection system according to any one of supplementary notes 1 to 4, further including a control means for controlling the light source, the connection means, the identification means, and the measurement means.

### Supplementary Note 6

The MCF connection system according to any one of supplementary notes 1 to 5, wherein the characteristic is a wavelength of the inspection light.

### Supplementary Note 7

The MCF connection system according to any one of supplementary notes 1 to 5, wherein the characteristic is a pulse width of the inspection light.

### Supplementary Note 8

The MCF connection system according to any one of supplementary notes 1 to 5, wherein the characteristic is a duty ratio of a pulse of the inspection light.

### Supplementary Note 9

An MCF connection method including a first procedure for optically connecting an MCF transmission path including N cores and a first FIFO, wherein
N is an integer equal to or more than two, and
the first procedure includes:
inputting, to each of a plurality of cores in one end of the first FIFO, pieces of inspection light having different characteristics from one another;
optically connecting, for each core, another end of the first FIFO and a first end part forming one end of the MCF transmission path;
identifying a characteristic of the inspection light being output from a second end part forming another end of the MCF transmission path;
measuring, for each core of the MCF transmission path, first optical power indicating optical power of each of the N cores of the inspection light being output from the second end part, in association with the characteristic;
adjusting an optical axis between another end of the first FIFO and the first end part in such a way that a value of each piece of the first optical power falls within a predetermined range; and
fixing connection between another end of the first FIFO and the first end part.

### Supplementary Note 10

The MCF connection method according to supplementary note 9, wherein
one end of the first FIFO includes a plurality of single core fibers (SCFs) included in the first FIFO, and
another end of the first FIFO is an MCF included in the first FIFO.

### Supplementary Note 11

The MCF connection method according to supplementary note 9 or 10, further including a second procedure to be executed after the first procedure, wherein
the second procedure includes:
optically connecting, for each core, one end of a second FIFO and the second end part;
identifying the characteristic of the inspection light being output from another end of the second FIFO;
measuring, for each core of the MCF transmission path, second optical power being optical power of the inspection light being output from another end of the second FIFO, in association with the characteristic;
adjusting an optical axis between the second end part and one end of the second FIFO in such a way that a value of each piece of second optical power falls within a predetermined range; and
fixing the connection between the second end part and one end of the second FIFO.

### Supplementary Note 12

The MCF connection method according to supplementary note 11, wherein
one end of the second FIFO is an MCF included in the second FIFO, and
another end of the second FIFO includes a plurality of SCFs included in the second FIFO.

### Supplementary Note 13

The MCF connection method according to supplementary note 11 or 12, wherein at least one of the first procedure and the second procedure is controlled by a control means.

### Supplementary Note 14

The MCF connection method according to any one of supplementary notes 9 to 13, wherein the characteristic is a wavelength of the inspection light.

### Supplementary Note 15

The MCF connection method according to any one of supplementary notes 9 to 13, wherein the characteristic is a pulse width of the inspection light.

### Supplementary Note 16

The MCF connection method according to any one of supplementary notes 9 to 13, wherein the characteristic is a duty ratio of a pulse of the inspection light.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

For example, some or all of operations of the MCF connection system according to the example embodiments may be programed. The MCF connection system according to the example embodiments may include a computer that executes the program. The computer executes the program and thereby, may achieve some or all of functions of the MCF connection system according to the example embodiments. The computer is, for example, a logic device, a central processing device, or a digital signal processing device. The control device 900 described according to the example embodiments may include a computer. At least either of the first procedure and the second procedure may be controlled by the control unit 900. The program may be stored in a computer-readable and fixed non-transitory recording medium. The recording medium is, for example, a flexible disk, a fixed magnetic disk, and a non-volatile semiconductor memory. The program may be distributed via a network.

The configurations described according to the example embodiments each are not necessarily exclusive to one another. The action and the advantageous effect according to the present invention may be achieved by a configuration in which all or some of the above-described example embodiments are combined.

### Reference Signs List

1, 2, 2A, 3 MCF connection system
10 MCF transmission path
11 to 14 Core
21, 22 End part
100, 200 FIFO
101, 201 MCF
500, 500A, 550, 550A Light source
501 to 504 Laser diode (LD)
511, 521 Optical coupler
512 to 515, 522 to 525 Optical bandpass filter (OBPF)
520 ASE light source
600, 601 Optical switch
610 Optical wavelength meter
611 Optical spectrum analyzer (OSA)
620 to 624 Optical power meter (OPM)
631 to 634 Optical bandpass filter
651 Optical coupler
800, 801 Connection device
900 Control device

What is claimed is:

1. An MCF connection system comprising:
a multi core fiber (MCF) transmission path including N cores;
a first fan-in/fan-out (FIFO);
a light source that outputs, to one end of the first FIFO, N pieces of inspection light having different characteristics from one another;
a connection circuit configured to optically connect a first end part forming one end of the MCF transmission path and another end of the first FIFO;
an identification circuit configured to identify a characteristic of the inspection light being output from a second end part forming another end of the MCF transmission path; and
a measurement circuit configured to measure, for each core of the MCF transmission path, first optical power indicating optical power of each of the N cores of the inspection light being output from the second end part, in association with the characteristic, wherein
N is an integer equal to or more than two,
the light source inputs the inspection light to each of a plurality of cores in one end of the first FIFO, and
the connection circuit adjusts, for each core, an optical axis between another end of the first FIFO and the first end part in such a way that a value of each piece of the first optical power falls within a predetermined range, and, after adjusting an optical axis between another end of the first FIFO and the first end part, fixes connection between another end of the first FIFO and the first end part.

2. The MCF connection system according to claim 1, wherein
one end of the first FIFO includes a plurality of single core fibers (SCFs) included in the first FIFO, and
another end of the first FIFO is an MCF included in the first FIFO.

3. The MCF connection system according to claim 2, further comprising
a second FIFO, wherein
the connection circuit optically connects the second end part and one end of the second FIFO,
the measurement circuit measures, for each core of the MCF transmission path, second optical power being optical power of the plurality of pieces of inspection light being output from another end of the second FIFO, in association with the characteristic, and
the connection circuit adjusts an optical axis between the second end part and one end of the second FIFO in such a way that a value of each piece of the second optical power falls within a predetermined range, and, after adjusting an optical axis between the second end part and one end of the second FIFO, fixes connection between the second end part and one end of the second FIFO.

4. The MCF connection system according to claim 3, wherein
one end of the second FIFO is an MCF included in the second FIFO, and
another end of the second FIFO includes a plurality of SCFs included in the second FIFO.

5. The MCF connection system according to claim 1, further comprising a control circuit configured to control the light source, the connection circuit, the identification circuit, and the measurement circuit.

6. The MCF connection system according to claim 1, wherein the characteristic is a wavelength of the inspection light.

7. The MCF connection system according to claim 1, wherein the characteristic is a pulse width of the inspection light.

8. The MCF connection system according to claim 1, wherein the characteristic is a duty ratio of a pulse of the inspection light.

9. An MCF connection method comprising a first procedure for optically connecting an MCF transmission path including N cores and a first FIFO, wherein
N is an integer equal to or more than two, and
the first procedure includes:
inputting, to each of a plurality of cores in one end of the first FIFO, pieces of inspection light having different characteristics from one another;
optically connecting, for each core, another end of the first FIFO and a first end part forming one end of the MCF transmission path;
identifying a characteristic of the inspection light being output from a second end part forming another end of the MCF transmission path;
measuring, for each core of the MCF transmission path, first optical power indicating optical power of each of the N cores of the inspection light being output from the second end part, in association with the characteristic;
adjusting an optical axis between another end of the first FIFO and the first end part in such a way that a value of each piece of the first optical power falls within a predetermined range; and
fixing connection between another end of the first FIFO and the first end part.

10. The MCF connection method according to claim 9, wherein
one end of the first FIFO includes a plurality of single core fibers (SCFs) included in the first FIFO, and
another end of the first FIFO is an MCF included in the first FIFO.

11. The MCF connection method according to claim 9, further comprising a second procedure to be executed after the first procedure, wherein
the second procedure includes:
optically connecting, for each core, one end of a second FIFO and the second end part;
identifying the characteristic of the inspection light being output from another end of the second FIFO;
measuring, for each core of the MCF transmission path, second optical power being optical power of the inspection light being output from another end of the second FIFO, in association with the characteristic;
adjusting an optical axis between the second end part and one end of the second FIFO in such a way that a value of each piece of second optical power falls within a predetermined range; and
fixing connection between the second end part and one end of the second FIFO.

12. The MCF connection method according to claim 11, wherein
one end of the second FIFO is an MCF included in the second FIFO, and
another end of the second FIFO includes a plurality of SCFs included in the second FIFO.

13. The MCF connection method according to claim 11, wherein at least one of the first procedure and the second procedure is controlled by a control circuit.

14. The MCF connection method according to claim 9, wherein the characteristic is a wavelength of the inspection light.

15. The MCF connection method according to claim 9, wherein the characteristic is a pulse width of the inspection light.

16. The MCF connection method according to claim 9, wherein the characteristic is a duty ratio of a pulse of the inspection light.
